(19) United States
(12) Patent Application Publication
(10) Pub. No.: US 2018/0065517 A1
(43) Pub. Date: Mar. 8, 2018

(54) VIBRATION MODULE FOR INTEGRATION INTO A MOTOR VEHICLE SEAT, MOTOR VEHICLE SEAT AND A METHOD FOR INTEGRATING THE VIBRATION MODULE INTO A MOTOR VEHICLE SEAT

(71) Applicant: GM GLOBAL TECHNOLOGY OPERATIONS LLC, Detroit, MI (US)

(72) Inventors: Christian KUHLEY, Ruesselsheim (DE); Juergen MAIER, Ruesselsheim (DE); Martin STEIN, Ruesselsheim (DE)

(73) Assignee: GM GLOBAL TECHNOLOGY OPERATIONS LLC, Detroit, MI (US)

(21) Appl. No.: 15/693,771

(22) Filed: Sep. 1, 2017

(30) Foreign Application Priority Data
Sep. 2, 2016 (DE) 102016010651.4

(51) Int. Cl. B60N 2/44; A61H 23/02

(52) U.S. Cl. CPC B60N 2/448; A61H 23/02; A61H 2205/086; A61H 2203/0431; A61H 2205/081; A61H 2201/0149

(57) ABSTRACT

A vibration module for integration into a vehicle seat includes a plurality of vibration elements, a first flat covering layer and a second flat covering layer. The vibration elements are arranged between the first covering layer and the second covering layer. The positions of the vibration elements are fixed relative to the first covering layer and/or second covering layer.

### CROSS-REFERENCE TO RELATED APPLICATION

This application claims priority to German Patent Application No. 102016010651.4, filed Sep. 2, 2016, which is incorporated herein by reference in its entirety.

### TECHNICAL FIELD

The present disclosure pertains to a vibration module for integration into a motor vehicle seat, a vehicle seat having the vibration module, and a method for integrating a vibration module into a motor vehicle seat.

### BACKGROUND

The comfort for a driver and/or passengers in a vehicle is gaining increasing importance by the integration of a wide variety of components. For example, massage modules in seats of a motor vehicle are being used as an effective way to improve the blood circulation in the musculature of a driver and/or passenger. The devices are usually installed into a car seat by an operator during the production of the vehicle seat.

DE 37 13 370 C2 discloses a massage device and a vehicle seat having the massage device. The massage device includes a base, at least one motor compartment, which is implemented on the base, at least one spring chamber which is implemented on the base, a motor which is arranged in the motor compartment, a volute spring which is arranged in the spring chamber. The motor is rotated in the motor compartment and transmits a vibration for the base onto the volute spring and from this onto the air in the spring chamber. Ultrasound-like vibrations are generated that can be used for massaging the driver.

### SUMMARY

The present disclosure provides a massage module for a motor vehicle seat, which is very easy to integrate into a vehicle seat. Exemplary embodiments of the present disclosure are obtained from the following description and/or the attached figures.

A vibration module for integration into a vehicle seat, a seat for a passenger car and/or lorry, is described and illustrated. The vehicle seat includes a backrest and a seat cushion. The vibration module may be either permanently integrated into the vehicle seat or else integrated only occasionally into the vehicle seat. The inclusion and/or exclusion of the vibration module into a car seat is possible in a simple manner.

The vibration module includes a plurality of vibration elements. In particular, the vibration module includes a plurality of vibration elements, for example from two to six or more vibration elements. The vibration elements may be for example, electrical, electromagnetic, mechanical, electro-mechanical or pneumatic vibration elements. The vibration elements may be in the form of a vibration motor, for example, electric motors with an imbalance. Alternatively and/or additionally, the vibration elements may be vibration-enabled piezo elements. In particular, the plurality of vibration elements may be identical in type and/or configuration. Alternatively, the plurality of vibration elements are vibration elements of different configurations and/or different types.

The vibration module includes a first flat covering layer and a second flat covering layer. In particular, the first and/or second covering layer has a covering layer surface. The covering layer surface is smaller than or equal in area to a contact surface of the vehicle seat. The contact surface is the surface with which a driver or passenger comes into physical and/or the contact area of the vehicle seat. The flat first and/or second covering layer has a covering layer surface area in a range of 10-100 square centimeters or more. The first and/or the second covering layer may have a thickness in a range of 1-5 millimeters or less. The area, the shape and/or the thickness of the covering layer surface of the first covering layer are preferably identical to the area, shape and/or thickness of the covering layer surface of the second covering layer.

The vibration elements are arranged between the first and second covering layer. In particular, the vibration elements may be equally distributed over the covering layer surface between the first and second planar covering layer. Alternatively and/or additionally, the vibration elements are arranged in the pattern which may form a matrix, a circular or any irregular pattern on the covering layer surface between the planar covering layers. It is particularly preferable to arrange the vibration elements in rows between the covering layers. The first and/or the second covering layer have a covering layer surface in which the covering layer surface has a covering layer width and a lengthwise extension. The vibration elements are arranged along a row and the rows are spaced apart in the longitudinal direction, the rows being positioned preferably perpendicular to the longitudinal direction.

The positions of the vibration elements relative to the first and/or second covering layer are fixed. In particular, a position is defined as being a central position of the vibration elements. The vibration elements are moveable around the central position in a range of less than one centimeter about the central position. Preferably, the fixing of the position of the vibration elements is maintained by the way in which they are arranged between the two covering layers.

The first covering layer and/or the second covering layer are fabricated from a non-rigid material. Preferably, the first covering layer and/or the second covering layer have a low modulus of elasticity of less than 0.5 Gigapascal, a low tensile strength and/or a large deformation due to loading with low forces or moments. Preferably, the first covering layer and the second covering layer are reversibly malleable and/or elastic. For example, the first covering layer and/or the second covering layer are configured as a mat, a foil or a cushion.

A consideration of the present disclosure is to provide a particularly easily integrated and cost-effective means for installing vibration elements in a vehicle seat. In particular, a consideration of the present disclosure is to create a module which enables an integral installation of a plurality of vibration elements into a vehicle seat, wherein a coarse positioning of the vibration elements in the module is obtained and a final positioning in the motor vehicle seat is permitted by the use of a non-rigid material for the construction of the module.

In an exemplary embodiment, the non-rigid first covering layer and/or second covering layer is configured as a synthetic non-woven fabric, a plastic foil or a metal foil, or is formed by a mixed material or multicomponent material, such as a laminate material. For example, the first covering layer or the second covering layer is configured as a non-woven fabric, for example a polypropylene non-woven. In particular, the first covering layer and/or the second covering layer may be constructed from a fibrous fabric.

In a possible embodiment of the present disclosure, the vibration module includes at least one electrical cable for supplying power to the vibration elements. The electrical cable has a cable route in the vibration module. To secure the cable route the electrical cable is arranged between the first covering layer and the second covering layer, at least in some sections. The electrical cable includes a main electrical cable and branches from the main electrical cable. The main electrical cable supplies the branches with power and the branches are electrically connected to the vibration elements. The vibration elements are supplied with current via the branches. Alternatively and/or in addition, the vibration module includes a plurality of electrical cables. The vibration module includes the same number of electrical cables as vibration elements, each vibration element being supplied with power with its own electrical cable. It is also possible, if a plurality of electrical cables is used, to route the electrical cables centrally and/or bundled together as a cable trunk. The electrical cable, or cable route, may be defined by the arrangement between the first and second covering layer. For example, the cable route may correspond to a mean position. The mean position of the cable route is defined, but the electrical cable can be moved in an area of less than 5 millimeters about this mean cable route. As an alternative and/or in addition, the electric cable can be routed outside the gap between the first and second covering layer, for example on an outer surface of the first and/or second covering layer. The electrical cable is, for example, glued or stapled to the first and/or second covering layer.

This configuration is based on the desire to further facilitate the simplified integration of a plurality of vibration elements into a vehicle seat by the arrangement of the vibration elements between two surface layers, by also specifying the cable route, for example with the first covering layer and/or the second covering layer, so that when installing the vibration module into a vehicle seat, the vibration module may be easily handled and the electrical cable and/or electrical cables can be installed without cable tangles.

The first covering layer and the second covering layer may be materially bonded together, at least in some sections. For example, the materially bonded connection is made by gluing or fusing the first and second covering layer. Alternatively and/or in addition, the first covering layer and the second covering layer are connected together in a positive fitting manner by stamping and/or sewing. The materially bonded connection of the two covering layers is preferably effected on the outer sides of the first and/or second covering layer. Alternatively and/or in addition, the materially-bonded connection of the first and second covering layer takes place in such a way that the vibration elements and/or the electrical cable are held securely against loss.

In particular, the materially bonded connection process may be a welding of the first covering layer and the second covering layer. Due to the welding, at least one weld seam is formed. The welding of the first covering layer and the second covering layer involves an ultrasonic welding of the two cover layers. The weld seam forms, at least in some sections, a positive-fitting boundary around the vibration elements and/or the electrical cable. For example, the positive-fitting retention is effected by the weld, such that a vibration element is surrounded by a closed path. The closed path is formed by the weld seam. For example, such a path is configured as a circle, an ellipse, or as an arbitrary polygon. The welding of the first covering layer and the second covering layer may be effected by hot caulking, heating element welding, laser transmission welding, circular welding or hot gas welding process. The materially-bonded connection of the first covering layer to the second covering layer may be an irreversible connection of the two covering layers, alternatively and/or additionally the connection of the two covering layers is a reversible connection.

The first covering layer and the second covering layer may form a blister-like and/or laminated packaging-like structure. For example, the first covering layer includes bowl-shaped indentations. The indentations are configured to receive at least one vibration element each. The second covering layer is flat and/or smooth. The second covering layer is connected to the first covering layer, which has the bowl-shaped indentations, such that the second covering layer forms a rear wall to the bowl-shaped indentations and thus forms a cavity between the first covering layer and second covering layer.

This configuration is based on the consideration that the indentations which receive the vibration elements can be easily integrated into a seat, into the foam material of a seat. The second covering layer closes off these indentations and terminates the second covering layer in a positive-fitting manner and/or flush with the vehicle seat.

In one possible embodiment of the present disclosure, the vibration module has reinforcing sections. The reinforcing sections reinforce the vibration module and/or the first and/or second covering layer locally and/or in a confined area, and thus increase the mechanical strength of the vibration module and/or of the first and/or second covering layer. The reinforcing sections can be, for example, sections of the welds, which are produced by welding of the first and second covering layer. Alternatively and/or additionally, the reinforcing sections are separate components, which are arranged between the first and second covering layer and promote a reinforcement of the vibration module in at least one spatial direction. Such separate reinforcing sections can be, for example, struts and/or bars, such as metal fins. These sections ensure reinforcement in the lengthwise extension of their stiffener section. The reinforcing sections and/or the increase of the local mechanical strength of the vibration module preferably take effect in the longitudinal extension of the vibration module, but can also take effect in the width of the vibration module or in any direction within the two-dimensional extension of the first and/or second covering layer.

This configuration is based on the consideration that the local and/or confined increase in strength by reinforcing sections allows the vibration module to be moved into a coarse position by an operative in advance, and yet the vibration module to continue to be held elastically during installation, so that the vibration elements in the motor vehicle seat can be brought into a final position.

The vibration module may include mounting units for mounting the vibration module on the motor vehicle. The mounting elements are, for example, hooks, eyelets or other interface elements that can be coupled to mating interfaces in a motor vehicle seat, so that the vibration module can be held in position in the motor vehicle seat.

At least a part of the vibration elements of the vibration modules may be configured as vibration massage elements. The vibration massage elements have massage heads, for example, which can be arranged in a motor vehicle seat such that the massage heads are also oriented towards a seated occupant and provide a massage effect. In particular, the vibration massage element is configured to perform a massage function in a continuous operation or in a pulsed operation. In addition, the frequency at which the vibration massage module performs the massage function is in a range from a few Hertz up to fifty Hertz. This frequency is preferably individually controllable.

In a possible extension of the present disclosure, the vibration module includes a heating element for supporting a massage function of the vibration massage elements. The vibration massage module can include a plurality of heating elements. The number of heating elements is the same as the number of vibration elements. It is also possible for the heating element to be configured as a heating mat positioned flat on a surface of the vibration module, for example the first covering layer or the second covering layer. Alternatively, the heating elements are configured as flat or point-like heating elements.

This configuration is based on the consideration that the vibration massage elements promote the blood circulation of a seated occupant. This effect can be further increased using the heating element. In particular for long distance driving, long-haul flights or long periods of sitting, the massage function and/or the heating element promotes the comfort of the vehicle seat for an occupant.

In a further configuration of the present disclosure, at least a part of the vibration elements is configured as a structure-borne sound transducer. The structure-borne sound transducer is configured to generate low frequencies of an audio segment in the form of waves and/or vibrations and provide them to a seated occupant. These vibrations are transmitted directly via the vehicle seat, so that the listening experience for a seated occupant is enhanced. The structure-borne sound transducer includes one or more mounted weights which are excited into vibration by one or more coils. The frequency response of the structure-borne vibration transducer is preferably between 4 Hertz and 45 Hertz.

The vibration module may include an upper module region, a central module region and a lower module region, each with at least two vibration elements. The module regions are spaced apart in the longitudinal direction and arranged, for example, in rows. It is provided that the lower, central and upper module region are flat regions in the vibration module, such as strip-shaped sections. The vibration elements are arranged in these sections. It is also provided that the vibration elements are arranged within a module region along the width of the module.

The present disclosure also provides a vehicle seat for a motor vehicle. The motor vehicle can be a passenger car, or a lorry. In particular, the vehicle seat has a backrest and seat cushion. A plurality of vibration elements may be integrated in the seat backrest and/or a plurality of vibration elements may be integrated in the seat cushion.

In one possible configuration of the present disclosure, the vehicle seat includes a base body. The base body has a base body wall with recesses as receiving and support points for receiving the vibration module and/or the vibration elements. The body is, for example, a foam body, the outer walls of which form the base body. The body panel of the base body which faces towards or away from the occupant of the vehicle seat includes the recesses. The recesses are larger than or the same size as the vibration elements. In particular, the recesses are configured such that each recess can accommodate exactly one vibration element. The receiving interfaces and/or the recesses in the base body fix and/or define the position of the vibration elements within the motor vehicle seat. For example, it is possible that the bowl-shaped indentations and/or bulges of the blister-like structure of the covering layers are inserted into the recesses. The second covering layer, which forms the rear wall to the indentations, terminates flush with the base body wall.

This configuration is based on the consideration that the receiving interfaces facilitate the fixation of the vibration elements and/or the vibration module in the motor vehicle seat. The flush termination by means of the second covering layer allows a barely noticeable integration, particularly visually or physically.

In a possible extension of the present disclosure, the vehicle seat has a seat backrest with an upper backrest region, a central backrest region and a lower backrest region. The lower backrest region is the region of the vehicle seat in which the lower back of an occupant is positioned and the upper region of the vehicle seat is the region in which the neck of an occupant is arranged when using the vehicle seat. It is provided that the upper module region is arranged in the upper backrest region, the central module region is arranged in the middle of the backrest region and the lower module region is arranged in the lower region of the backrest.

This configuration is based on the consideration that the vibration modules should be integrated in such a way that in a motor vehicle seat, the regions of the occupant's back that are massaged by the vibration elements are those regions which are most frequently liable to tension during long periods of sitting.

The present disclosure also provides a method for integrating a vibration module as set forth above into a vehicle seat. The vehicle seat preferably includes a foam body. The foam body is also designated as a seat foam section, which includes receiving interfaces for receiving the vibration module and/or vibration elements. The receiving interfaces are configured in particular as recesses in the seat foam section. The vibration module with the plurality of vibration elements is inserted and/or integrated into the receiving interfaces as a single part in one step by an operative or a robot system.

This configuration of the present disclosure is based on the consideration to integrate a plurality of vibration elements in only one process step into a vehicle seat. Based on the first and second covering layer, which are produced from a non-rigid material, the final position of the vibration elements in the vehicle seat can be more precisely defined during installation.

### BRIEF DESCRIPTION OF THE DRAWINGS

The present disclosure will hereinafter be described in conjunction with the following drawing figures, wherein like numerals denote like elements.

FIG. 1 shows a vibration module with six vibration elements;

FIG. 2 is an expanded view of the vibration module;

FIGS. 3a, 3b and 3c are sections through the vibration module;

FIG. 4 shows a vehicle seat in an exploded view;

FIG. 5 shoes seat backrest of the vehicle seat; and

FIGS. 6a and 6b are sections through the vehicle seat.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

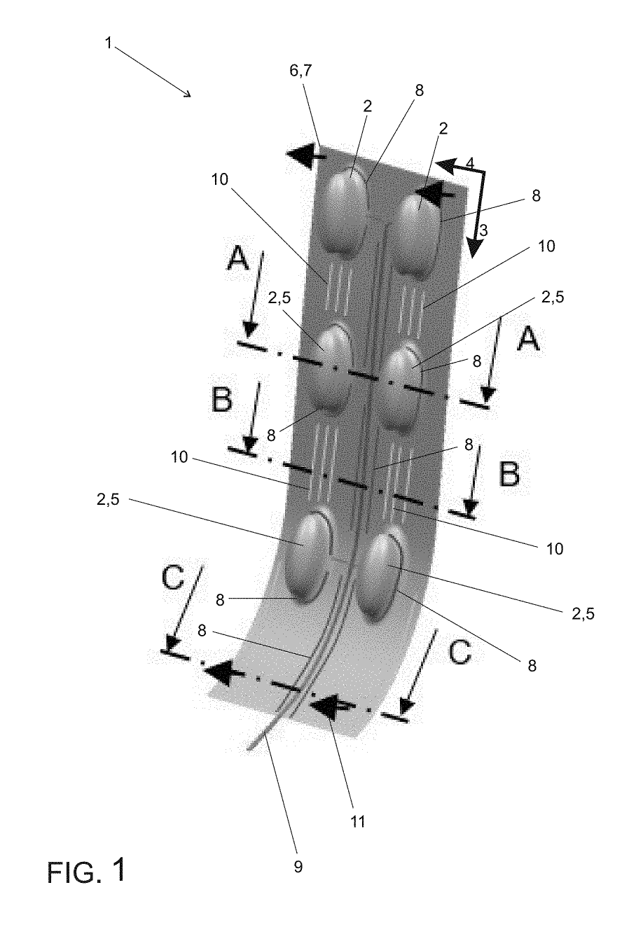

FIG. 1 shows a vibration module 1 which includes six vibration elements 2. The vibration module 1 has a lengthwise extension 3 and a vibration module width 4. In addition, the vibration module 1 extends in two-dimensions and includes indentations 5, which can also be construed as bulges, in which the vibration elements 2 are arranged. The vibration elements 2 are arranged in the vibration module 1 in a matrix-like fashion. In an exemplary embodiment there are always two vibration elements 2 arranged in a line in one row of the vibration module 1. The vibration elements 2 are also arranged one below the other in columns. The columns run in the longitudinal extension 3.

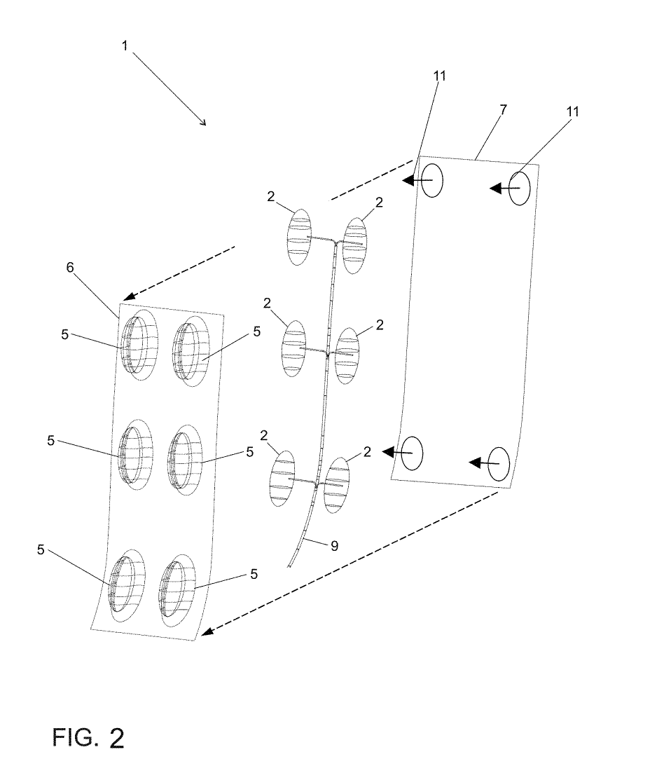

The vibration module 1 includes a first covering layer 6 (FIG. 2) and a second covering layer 7 (FIG. 2). The first covering layer 6 and the second covering layer 7 are produced from a non-woven polypropylene fabric. The vibration elements 2 are arranged between the first covering layer 6 and the second covering layer 7. The first covering layer 6 and the second covering layer 7 are materially bonded together, at least in some sections. This connection in this exemplary embodiment is implemented as a welding process, which results in weld seams 8. The vibration elements 2 are each surrounded by a weld seam 8, so that the vibration elements 2 are securely held against loss between the first covering layer 6 and second covering layer 7 at a central position. The position and/or central position is specified in particular relative to the first covering layer 6 and/or second covering layer 7.

The vibration module 1 also includes an electrical cable 9, via which the vibration module 1 can be supplied with electrical energy. The electrical cable 9 includes branches, which supply electrical contacts of the vibration elements 2 with power from the electrical supply cable 9. The electrical cable 9 is arranged between two weld seams 8, so that the electrical cable 9 is also held within the vibration module 1 at a central position between the welds 8. The vibration module 1, the first covering layer 6 and the second covering layer 7, are made of a non-rigid material. The non-rigid material has a low modulus of elasticity of less than 0.08 Gigapascals. In order to increase the stability of the vibration module 1 in the regions between the vibration elements 2, reinforcing sections 10 are arranged between the rows in which the vibration elements 2 are arranged. The reinforcing sections 10 in this exemplary embodiment are implemented as weld seams in the longitudinal extension 3. The weld seams 8 are arranged parallel to each other. Alternatively and/or additionally, the reinforcement sections 10 can also be implemented as weld seams 8 which are crossed, for example.

The vibration module 1 is configured as a blister-like vibration module 1. The vibration module 1 includes bulges or indentations 5 in which the vibration elements 2 are arranged and wherein the bulges or indentations 5 are sealed at the rear by a flat and/or smooth second covering layer 7, so that the vibration elements 2 are arranged in the indentations 5 securely against loss. The mounting direction 11 indicates the direction oriented towards an occupant of a motor vehicle seat. The vibration elements 2 and the indentations 5 or bulges are arranged in such a way that the occupant of the vehicle seat is massaged by the vibration elements 2. In this exemplary embodiment, the first covering layer 6 is arranged on the side of the mounting direction 11, in other words the side which faces an occupant of the vehicle seat. The second covering layer 7 is arranged on the side of the vibration module 1 contrary to the mounting direction 11, i.e. facing away from an occupant of the vehicle seat.

FIG. 2 shows an exploded view of the vibration module 1 of FIG. 1. The vibration elements 2 are arranged between the first covering layer 6 and the second covering layer 7. The first covering layer 6 includes indentations 5. The indentations 5 represent bulges in the direction of the mounting direction 11. The indentations 5 have the shape and contour and/or size of the vibration elements 2, so that the vibration elements 2 can be placed into the indentations 5. The vibration elements 2 also have an egg-shaped form having a size, for example, of about a chicken's egg. The first covering layer 6 is in particular curved and/or convex in the region of the indentations 5 only. The remaining part is substantially non-curved and/or flat.

The vibration elements 2 have electrical contacts, the electrical contacts being connected to the electrical cable 9. The electrical cable 9 forms a main wiring strand, wherein secondary strands branch off from the main wiring strand that contact the electrical contacts of the vibration elements 2.

The second covering layer 7 is configured as a flat, level and/or substantially non-curved covering layer. This covering layer is a non-woven polypropylene fabric, for example. The second covering layer 7 in particular has the same contour and/or shape as the first covering layer 6, so that the first covering layer 6 and second covering layer 7 can be arranged one above the other in congruence. In particular, the first covering layer 6 and second covering layer 7 are connected together in a materially-bonded manner, which is effected by gluing and/or welding of the two covering layers 6, 7.

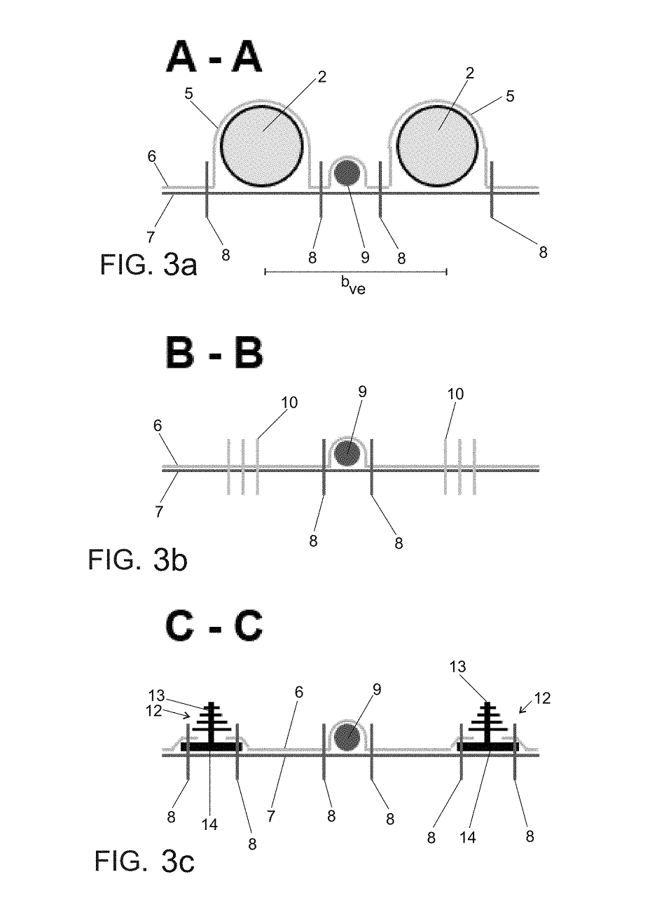

FIG. 3a shows a section through the vibration module 1 of FIG. 1 along the line A-A. The vibration elements 2, which have a circular cross-section along this section line, are arranged at a vibration element interval bvE. The vibration element interval bvE is preferably greater than fifty millimeters and less than two hundred millimeters. The electrical cable 9 is arranged centrally between the vibration elements 2. The second covering layer 7 is configured here as a flat covering layer, on which the vibration elements 2 and the electrical cable 9 rest. The vibration elements 2 and the electrical cable 9 are covered by the first covering layer 6 so that the former are arranged between the first covering layer 6 and the second covering layer 7. In particular, the first covering layer 6 covers the vibration elements 2 and the electrical cable 9 such that they are securely held against loss and/or pressed onto the second covering layer 7. The vibration elements 2 are surrounded by a weld seam 8, which in this sectional view appears as a weld seam 8 to the left and right of the vibration elements 2. The electrical cable 9 is also held securely against loss by a weld seam 8 to the left and right. The weld seam 8 is formed to the left and right of the electrical cable 9, in each case by one weld seam 8, to hold the vibration elements 2.

FIG. 3b shows a section along the line B-B by the vibration module 1 of FIG. 1. The section is made here through a region of vibration module 1, in which no vibration elements 2 are arranged along the section. Arranged centrally along the cut is the electrical cable 9, which is surrounded to the left and right by a weld seam 8, which connect the first covering layer 6 and the second covering layer 7 to each other and position the electrical cable 9 at a central location secured against loss. To the left and right of the electrical cable 9 are in each case three reinforcing sections 10, which are configured as weld seams 8 and increase the rigidity of the vibration module 1 in the longitudinal extension 3, so that, for example, the vibration module 1 can be moved by an operative into an approximate position before installation, but can be adjusted by the operative into the exact position later on final installation in a motor vehicle seat 15.

FIG. 3c shows a section through the vibration module 1 from FIG. 1 along the line C-C. The section here is made in a region in which two mounting elements 12 are arranged. The mounting elements 12 are arranged between the first and the second covering layer 6, 7. The mounting elements 12 have a mounting section 13 which penetrates the first covering layer 6 and is used for mounting in the car seat 15. The mounting element 12 also has a retaining section 14, which here is configured as a flat structure and is arranged between the first covering layer 6 and second covering layer 7. The retaining section 14 holds the mounting element 12 between the first and second covering layer 6, 7, wherein a weld seam 8 is arranged to the left and right of the retaining section 14, so that the mounting element 12 is stabilized in a region and held securely against loss. The mounting elements 12 with the mounting section 13 can be configured, for example, as clips that clip into a fixing element mating interface in the vehicle seat 15, and thus stabilize and hold the vibration module 1 at one location. The mounting elements 12 are in particular arranged on the outer sides of the vibration module 1 along the vibration module width and/or longitudinal extension 3.

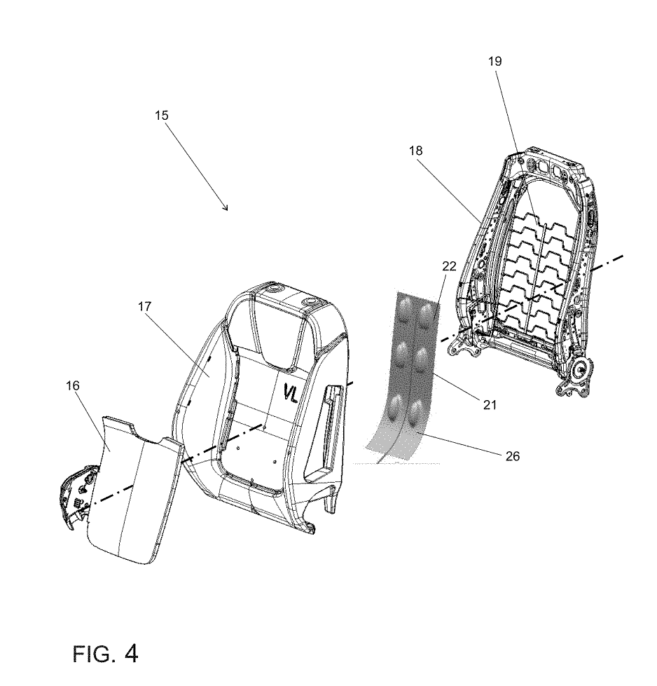

FIG. 4 shows a vehicle seat 15 in an expanded view. The vehicle seat 15 includes a seat cover 16, a seat foam section 17, the vibration module 1, a lumbar support 18 and a base body 19 with suspension. The seat cover 16 may for example include cushioning. The seat cover 16 faces towards an occupant of the vehicle seat 15, and is arranged on the seat foam section 17. The vibration module 1 is arranged between the seat foam section 17 and lumbar support 18 and/or base body 19. The lumbar support 18 in this exemplary embodiment is part of the base body 19. The lumbar support 18 points in the direction of the occupant of the vehicle seat 15.

The vibration module 1 has a lower module region 20, a central module region 21 and an upper module region 22. The module regions 20, 21 and 22 are each separated by reinforcing sections 10. Each of the module regions 20, 21 and 22 has two vibration elements 2 to 9 each, which are supplied with power by an electrical cable, so that they can be used as massage elements in a vibration mode. Each seat foam section 17 has recesses. The recesses have the same size, shape and/or contour of the vibration elements 2. The vibration module 1 and/or the vibration elements 2 can therefore be arranged in the recesses, so that the lumbar support 18 and/or the base body 19 can close off the seat foam section 17 in a positive-fitting manner and the vibration module 1 is securely held against loss between seat foam section 17 and base body 19.

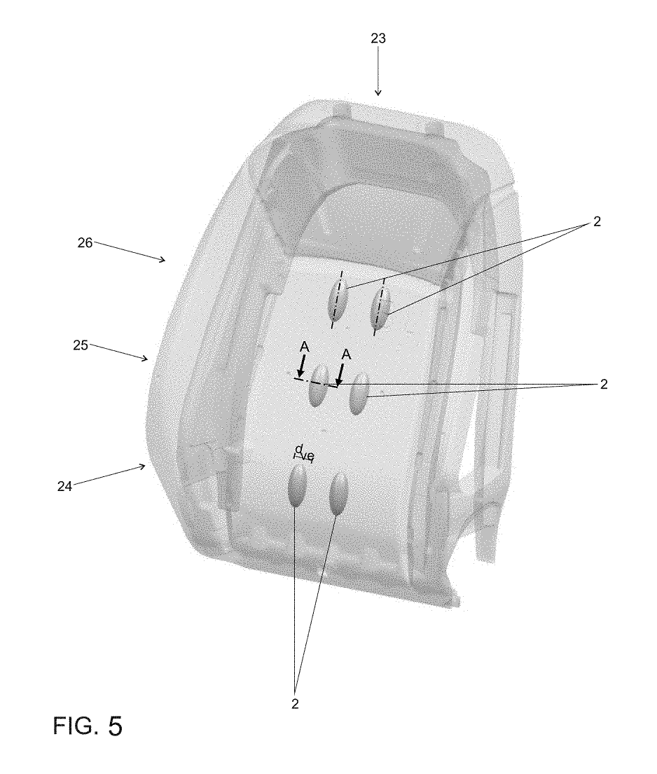

FIG. 5 shows the seat backrest of the vehicle seat 15 of FIG. 4, in which the vibration module 1 is arranged. The seat backrest 23 includes a lower backrest region 24, a central backrest region 25 and an upper backrest region 26. The lower module region 20 is arranged in the lower backrest region 24, the central module region 21 is arranged in the central backrest region and the upper module region 22 is arranged in the upper backrest region 26. The lower backrest region 24 corresponds to the section in the motor vehicle seat 15 in which the lower back of an occupant of the seat is positioned. The central backrest region 25 is the section in which the central part of the back of an occupant of the vehicle seat 15 rests. The upper backrest region 26 is the region of the motor vehicle seat 15 in which the neck of an occupant of the vehicle seat 15 is positioned. The vibration elements 2 in this exemplary embodiment are configured as egg-shaped vibration elements 2, which have a typical vibration element width dvE of between two centimeters and ten centimeters.

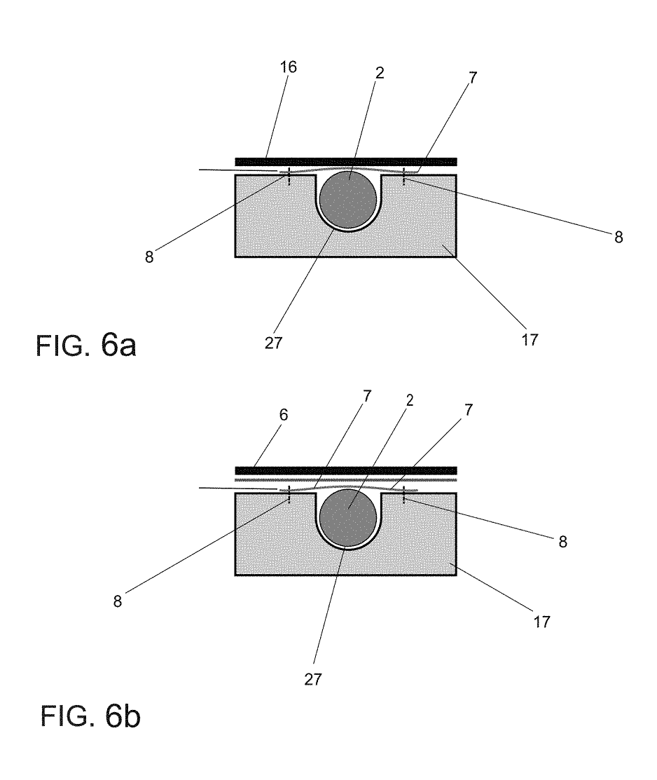

FIG. 6a shows a section through the motor vehicle seat 15 of FIG. 5 along the line A-A. This excerpt shows the recess 27 in the seat foam section 17, which in this case is bowl-shaped, and has a depth which allows a vibration element 2 to be accommodated in the recess in the 27 such that the vibration element 2 protrudes from the recess by only a few millimeters. The vibration module 1 is surrounded by the first and the second covering layer 6, 7 and held securely therein against loss by means of weld seams 8. The second covering layer 7 is joined to the seat cover 16, which is attached in planar fashion to the seat foam section 17. The vibration element 2 is configured to act through the second covering layer 7 and the seat cover 16 and to massage an occupant of the passenger car.

FIG. 6b shows a section through the motor vehicle seat 15 of FIG. 5 along the line A-A as an alternative and/or supplementary exemplary embodiment of FIG. 6a. In this exemplary embodiment, between the second covering layer 7 and the seat cover a heating element 28 is arranged. The heating element 28 here is implemented as a flat mat and heats the lower, middle and/or the upper backrest region 24, 25, 26.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15 (canceled)

16. A vibration module for integration into a motor vehicle seat comprising:
a first flat covering layer fabricated from a non-rigid material;
a second flat covering layer fabricated from the non-rigid material; and
a plurality of vibration elements, wherein the plurality of vibration elements arranged between the first covering layer and the second covering layer in a fixed position.

17. The vibration module according to claim 16, wherein the non-rigid material comprises at least one of a synthetic non-woven fabric, a plastic sheet, a metal foil, or a foil made from mixed material.

18. The vibration module according to claim 16, wherein the vibration module further comprises at least one electrical cable configured to power to the plurality of vibration elements, wherein the electrical cable is fixed along a cable route in the vibration module between the first covering layer and the second layer.

19. The vibration module according to claim 16, further comprising a materially bonded connection between the first covering layer and the second covering layer.

20. The vibration module according to claim 19, wherein the materially bonded connection comprises a welding of the first and second covering layers forming at least one weld seam providing a positive-fitting boundary for the electric cable, one or more vibration elements or a combination thereof.

21. The vibration module according to claim 16, wherein the first and second covering layers form a laminated structure around the plurality of vibration elements.

22. The vibration module according to claim 16, wherein the first covering layer comprising a plurality of bowl-shaped indentations each receiving at least one vibration element with the second covering layer forming a flat rear wall.

23. The vibration module according to claim 16, wherein the vibration module comprises reinforcement sections providing a local increase in the mechanical strength of the vibration module.

24. The vibration module according to claim 16, wherein at least one of the plurality of vibration elements comprises a vibration massage element.

25. The vibration module according to claim 24, wherein the vibration module further comprises a heating element for providing a massage function of the vibration massage elements.

26. The vibration module according to claim 16, wherein at least one of the plurality of vibration elements are configured as a structure-borne vibration transducer.

27. The vibration module according to claim 16, wherein the vibration module further comprises an upper module region, a central module region and a lower module region, wherein the module regions are spaced apart in the longitudinal direction and each of the module regions include at least two vibration elements.

28. A vibration module for integration into a motor vehicle seat comprising:
a first flat covering layer fabricated from a non-rigid material; and
a second flat covering layer fabricated from the non-rigid material;
a plurality of vibration elements, wherein the plurality of vibration elements arranged between the first covering layer and the second covering layer in a fixed position;
at least one electrical cable configured to power to the plurality of vibration elements, wherein the electrical cable is fixed along a cable route in the vibration module between the first covering layer and the second layer; and
at least one weld seam between the first and second covering layers providing a positive-fitting boundary for the electric cable and the plurality of vibration elements

29. A motor vehicle seat for a motor vehicle comprising:
a seat base;
a backrest; and
a vibration module integrated into at least one of the seat base and the backrest, the vibration module including a first and second covering layers fabricated from a non-rigid material and a plurality of vibration elements, wherein the plurality of vibration elements arranged between the first and second covering layers in a fixed position.

30. The motor vehicle seat according to claim 29, wherein the seat base comprises a base body having a base body wall with openings defining a receiving interface for at least a portion of the vibration module, wherein the receiving interfaces fixedly position the vibration elements within the motor vehicle seat and one of the first covering layer or the second covering layer terminates flush with the base body wall.

31. The motor vehicle seat according to claim 30, wherein the backrest comprises an upper backrest region, a central backrest region and a lower backrest region and the vibration module comprises an upper module region arranged in the upper backrest region, a central module region arranged in the central backrest region and a lower module region arranged in the lower backrest region.
